(19) United States
(12) Patent Application Publication
(10) Pub. No.: US 2009/0210264 A1
(43) Pub. Date: Aug. 20, 2009

(54) Conversation Mode Booking System

(76) Inventors: Denise M. Anderson, New Market, MN (US); Milton P. Baker, Minneapolis, MN (US); Douglas W. Bock, Webster, MN (US); James Gibson, Apple Valley, MN (US); Michael J. Lawrence, Eden Prairie, MN (US); Mohd Saleem, Jaipur (IN); Khaja Moinuddin Mohammed, Rahmundry (IN); Giriprasad Murugeshan, Bangalore (IN); David W. Rohy, Darwin, MN (US); Donna L. Sundstrom, Prior Lake, MN (US)

Correspondence Address: UNISYS CORPORATION, UNISYS WAY, MAIL STATION: E8-114, BLUE BELL, PA, 19424, US

(21) Appl. No.: 12/430,402

(22) Filed: Apr. 27, 2009

Related U.S. Application Data
(62) Division of application No. 11/582,076, filed on Oct. 17, 2006.
(60) Provisional application No. 60/836,509, filed on Aug. 9, 2006.

(51) Int. Cl. G06Q 10/00; G06F 3/048; G06Q 50/00

(52) U.S. Cl. 705/5; 715/825

(57) ABSTRACT

A system to book events such as trips are discloses. The system provides a conversation mode that allows a booking to be created within retentive storage in a portable format. In one embodiment, this portable format is a string written in eXtensible Markup Language (XML). This format may be stored to a database using a single database access operation. According to another aspect of the system, a user may ignore selectable portions of the booking as the booking is being created such that an entire booking need not be discarded when it is determined that a single service or informational element included in that booking is no longer needed.

### CLAIM OF PRIORITY TO PARENT APPLICATION

This application is a divisional of Ser. No. 11/582,076 which was filed on Oct. 17, 2006 and claims priority to provisionally filed U.S. Patent Application Ser. No. 60/836,509 filed Aug. 9, 2006, attorney docket number RA-5831P entitled “Conversation Mode Booking System and Method”, which is incorporated herein by reference in its entirety.

### FIELD OF THE INVENTION

The present invention relates generally to an automated system for booking customers to receive services; and more particularly, to a system that provides a conversation mode for booking customers.

### BACKGROUND OF THE INVENTION

Providers of transportation and other services, including airlines, trains, bus companies, hotel chains, car rental services, and the like often employ some type of reservation system. Such systems are used to book customers to receive a provided service. Services may include an airline flight, the rental of a vehicle, the booking of lodging accommodations, and so on. In particular, transportation carriers such as airlines often employ relatively complex reservation and departure control systems (RDCS) that not only reserve flights for passengers and control activities on the day of departure, but are also capable of initiating the booking of other services as well. For instance, such systems may be capable of booking vehicles, lodging accommodations, and so on, that are required during a passenger's trip.

RDCS systems such as those used by the airlines process and manage customers using “booking data”. Booking data is defined as all of the information about a customer or a group of customers that are traveling together on the same trip. Such information, sometimes referred to simply as “a booking”, includes customer names, the number of segments in a journey, the transportation routes (e.g., flight segments) included within the journey, and any special requirements such as special meals, wheelchairs, etc. that may be needed by one or more of the members in the party while traveling on an airline flight.

A booking may further include car rental and hotel information, other reservation information associated with a customer's trip such as tour data, information regarding the manner in which the passengers are being ticketed, data regarding travel documents, payment information (e.g., credit card names/numbers), and information regarding any other accommodation or service associated with the journey.

Data is generally managed on a booking basis. That is, when a customer books the services associated with his or her trip, all of the information describing those services is stored as a booking record within retentive storage, such as in a database.

In prior art RDCS systems, information about a booking is created in local storage. During this process, a booking agent or some other travel representative employs some type of user interface to select the services to add to the booking. The agent also adds information concerning the people that are going to receive those services. When all information has been added to the booking, the agent has the option to indicate that all of the booking information should be stored to retentive storage such as a database maintained by the system. Alternatively, the agent may indicate that because some information associated with the booking is incorrect (e.g., it has been determined that one of the services will not be needed), the entire booking will be ignored. In other words, when using prior art systems, there is no way to indicate that only a select portion of the booking is to be ignored.

Another problem with prior art systems is that the final booking record that is stored to retentive storage is not readily portable. In other words, that booking record cannot be easily transferred to an end-user or another service provider. This makes is difficult for multiple service providers to utilize the same booking data to provide services.

Yet another limitation of prior art systems is that a booking record is generally stored in multiple database tables. Thus, when the record is stored, the database must be accessed multiple times, which is inefficient.

What is needed, therefore, is an improved system and method that addresses one or more of the foregoing limitations.

### SUMMARY OF THE INVENTION

A system and method are provided to book events such as trips. The system and method provides a conversation mode that allows a booking to be created within retentive storage in a portable format. In one embodiment, this portable format is a string written in eXtensible Markup Language (XML) format. This format may be stored to a database using a single database access operation instead of the multiple database access operations required by prior art systems to store the same data. According to another aspect of the system and method, a user may ignore selectable portions of the booking as the booking is being created. This makes the booking creation process more efficient, since an entire booking need not be discarded when it is determined that a single service included in that booking is no longer needed, as was required by prior art systems.

In one embodiment, a method operable on a data processing system for managing a booking for an event is disclosed. The method includes receiving data describing the booking, and determining a mode of operation. Data is stored as a working booking in a single working booking table if the mode of operation is determined to be a conversation mode. However, if the mode is determined to be an implied EOT mode, the data is stored in multiple booking database tables.

Another embodiment provides a computer-implemented method of managing a booking for an event. The method includes receiving data describing the booking, storing the data in one or more database tables, identifying a subset of the stored data that is eligible to be ignored, and ignoring any portion of the subset of data that is selected by a user. In one embodiment, ignoring a portion of the data may include at least one of reinstating a service that was canceled by the selected portion, reinstating information that was canceled by the selected portion, canceling a service that was added by the selected portion, and canceling information that was added by the selected portion.

Another adaptation of the invention relates to a data processing system for managing booking of events. The system includes a user interface to receive data describing an event, and persistence layer logic communicatively coupled to receive the data. The persistence layer logic stores the received data in a single working booking table if operating in a conversation mode, and stores the received data in multiple booking database tables if operating in an implied EOT mode.

Another aspect of the invention relates to a system for managing a booking for an event. The system comprises a user interface to receive data that describes the event. Persistence layer logic is coupled to the user interface to store a first version of the data that describes the event in a first format and to store a second version of the data that describes the event in a second format. The system also includes business method logic to compare the first version of the event and the second version of the event to identify a subset of the data that is eligible to be ignored.

In one embodiment, the invention includes a storage medium having stored thereon instructions to cause a processor to execute a method. The method includes receiving data that describes a booking for an event, and using the received data to perform at least one of canceling a service from the booking, deleting information from the booking, adding a service to the booking, and adding information to the booking. The method also includes allowing a user to initiate a partial ignore function for a portion of the received data that has not yet undergone an end-of-transaction process, the partial ignore function to perform at least one of reinstating a canceled service within the booking, reinstating deleted information within the booking, deleting an added service from the booking, and deleting added information from the booking.

The foregoing and other aspects of the current invention will become apparent to those skilled in the art from the following description and the accompanying drawings.

### BRIEF DESCRIPTION OF THE DRAWINGS

FIG. 1 is a block diagram illustrating an exemplary computing environment in which a Reservation Departure and Control System provides management and control services to a transportation carrier such as an airline.

FIG. 2 is a block diagram illustrating an exemplary embodiment of a Reservation Departure and Control System for hosting management services for one or more airline carriers.

FIG. 3 is a screen display that is included in an exemplary user interface that may be used by a Reservation Departure and Control System.

FIG. 4 is a display of an exemplary booking summary screen according to one aspect of the current invention.

FIG. 5 is a block diagram that illustrates operation of the implied EOT and conversation modes according to one embodiment of the current invention.

FIG. 6 is a screen display illustrating the addition of services to an existing booking.

FIG. 7 is a screen display generated when the partial_ignore function is invoked during the scenario of FIG. 6.

FIG. 8 is one embodiment of a method of providing Conversation and implied EOT modes according to the current invention.

FIG. 9 is one embodiment of a method of a partial_ignore function according to the current invention.

### DETAILED DESCRIPTION OF THE DRAWINGS

Before considering the invention in detail, a description of an exemplary Reservation and Departure Control System (RDCS) that may employ the current invention is provided for discussion purposes. It will be understood that the described system is provided by way of example only. Many other types of systems and system architectures may usefully employ the current invention. Additionally, while the following discussion primarily references the airlines industry, it will be understood that this is merely for exemplary purposes, and that the RDCS may be adapted for use by any service provider (e.g., a hotel chain), or any entity such as a travel agent that is making reservations on behalf of a service provider.

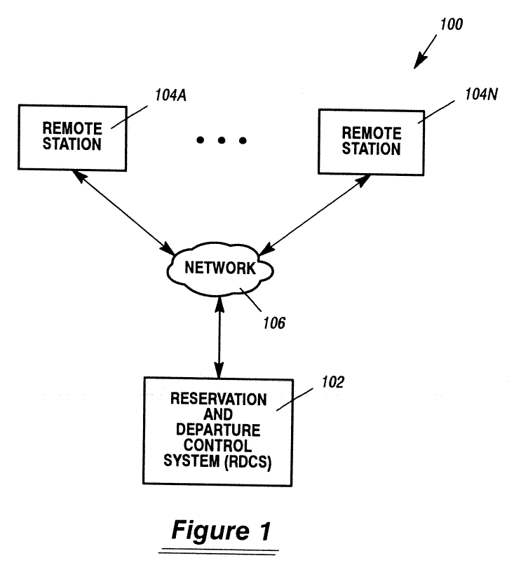

FIG. 1 is a block diagram illustrating an exemplary computing environment 100 in which an RDCS 102 provides management and control functions for a transportation carrier such as an airline. The services provided by RDCS are primarily directed to booking airline flights, but may also be used to book other types of services (also described herein as “products”) required for a trip. Such services may include ground transportation services, hotel accommodations, tours, and the like.

According to the current invention, services may be booked using a conversation mode. This allows a selected portion of the booking to be ignored without requiring that the entire booking be discarded. Conversation mode also creates a booking that is easily transportable between data processing systems of various service providers. In this manner, multiple service providers may reference the same booking data when providing services to customers associated with the booking. The use of conversation mode will be discussed in detail below.

As described in detail herein, RDCS 102 provides a user interface to allow authorized users residing at remote stations 104A-104N (“remote stations 104”) to perform a number of tasks associated with the booking of services such as flights and performing other related tasks. A user may be, for example, front-line staff, a system administrator, a control agent, or other authorized users. Exemplary tasks include retrieving basic customer data, retrieving credit card and other payment information, initiating re-booking activities such as re-booking a customer that has missed a flight, retrieving customer notification contact data, and so on. Remote stations 104 may be associated with a single airline or multiple airlines.

RDCS 102 presents a user interface, which may be a graphical set of interrelated screens that allow the users to initiate booking, check-in and re-accommodation activities for one or more flights. A user, such as front-line staff residing at one of remote stations 104, may submit a request to perform such activities, or such requests may be submitted automatically by one of the RDCS modules, as described below.

In one embodiment, each of the users associated with remote stations 104 accesses RDCS 102 via a network 106 using a remote computing device having suitable communication software such as a web browser. Network 106 may be any private or public network, and may include one or more Local Area Networks (LANs), Wide Area Network (WANs), wireless LANs or the like. Network 106 may also include one or more connected network devices (not shown), such as personal computers, laptop computers, handheld computers, workstations, servers, routers, switches, printers, fax machines or other devices.

A user may access RDCS 102 using a network-enabled computing device, such as a workstation, personal computer, laptop computer or a handheld device. The computing device executes the communication software needed in order to communicate with RDCS 102.

Remote stations 104 may include remote stations located in a single airport or, more likely, remote stations located in multiple airports. In addition, one or more remote stations 104 may be located outside of the airport environment. For example, one or more remote stations may be located within hotels, travel agencies or other locations. In another example, a user (e.g., a customer) may remotely access RDCS 102 via the Internet from a computing device located within a home or another location. Alternatively, a user may access RDCS 102 via a self-check-in terminal within an airport or other location. In still another embodiment, remote stations may be located at the same facility as RDCS 102.

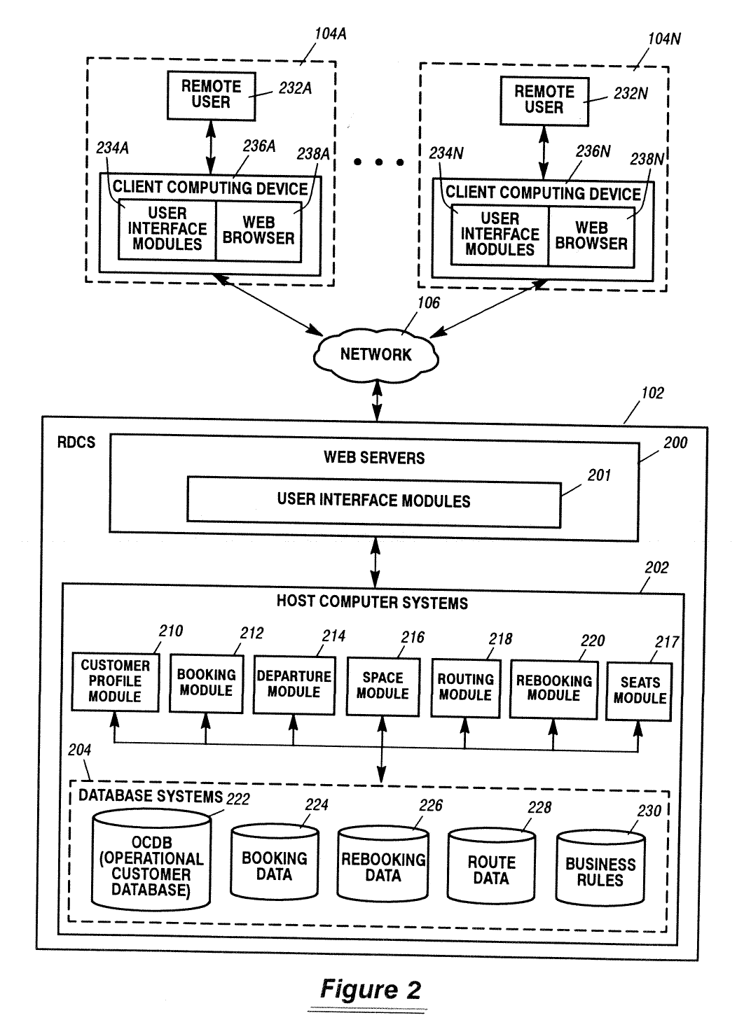

FIG. 2 is a block diagram illustrating an exemplary embodiment of RDCS 102 for hosting management services for one or more airline carriers. In the exemplary embodiment, RDCS 102 includes one or more web servers 200 coupled to host computer systems 202. Host computer systems 202 may include one or more servers executing the UNIX, Linux, Windows®, or any other operating system. Host computer systems 202 provide database systems 204 for storing data. Example database systems include SQL Server™ from Microsoft Corporation and the Oracle™ database from Oracle Corporation. Although illustrated separately, web servers 200 and host computer systems 202 may be integrated, and/or provided by one or more computing systems.

Host computer systems 202 execute software service modules 210-220. These service modules generally represent software modules having executable instructions to assist airline personnel in providing airline services. In this example, host computer systems 202 execute a customer profile module 210, a booking module 212, a departure module 214, a space module 216, a routing module 218, a rebooking module 220, and a seats module 217.

Customer profile module 210 allows a user to create, retrieve, and update customer profile data, which is stored within an Operational Customer Database (OCDB) 222. OCDB 222 provides a centralized repository for maintaining consistent, current customer data for use by any of the service modules 210-220 executed by host computer systems. Customer data may include customer contact data, customer preferences such as seating and meal preferences, preferred connection points, hotel and vehicle preferences, frequent flier information, billing and payment information, customer requirements and special requests (e.g., wheelchair requirements, special meal requests, etc.) and so on.

Turning next to booking module 212, this module receives and manages the booking data associated with airline flights. Within the travel industry, booking data is defined as all of the information about a passenger or a group of passengers that are traveling together on the same journey or participating in the same event. Such information, sometimes referred to simply as “a booking”, includes passenger names, which one or more flights are included within the journey, and any special requirements such as special meals, wheelchairs, etc. that may be needed by one or more members in the party. It may further include car rental and hotel information, the manner in which the passengers are being ticketed, data regarding travel documents, contact and payment information, and information regarding any other accommodation or service associated with the journey. This data is stored as booking data 224 within database systems 204.

In a larger context that extends beyond the travel industry, a booking may refer to all data that describes the goods and services required to conduct a particular event. For instance, a booking may contain the information to describe the goods and services that are booked for a business convention. Such information may describe services including the reservation of hotel rooms and conference rooms, the renting of office equipment (e.g., projectors, etc.), reservation of any catering services, limousine services, entertainment, and so on. This is discussed further below.

Departure module 214 manages the check-in process on the day of departure, including the check-in of passengers and baggage. For example, an airline employee, shown as one of remote users 232A-232N, may interact with departure module 214 to obtain the issuance of boarding passes and bag tags, and to manage standby passengers. In addition, a remote user may indicate any special needs and requests required by passengers as identified during the check-in process.

Space module 216 manages information regarding the space that is available on flights provided by the current carrier. For instance, this module controls sales restrictions for flights. This module may be coupled to an external space module (not shown), which provides information on space available on flights provided by other carriers. Another related module, seats module 217, provides information on the layout of each aircraft, including information concerning the seating configurations.

Routing module 218 utilizes predetermined flight data that describes the flights provided by the airline to determine the various route options that are available to customers. For example, routing module will determine the best way for a customer to travel from a desired departure location to a destination point using the flights hosted by this airline, or one or more other airlines.

Finally, re-booking module 220 is used to re-book passengers on alternative flights. For example, remote users 232 may interact with re-booking module 220 to re-book passengers following an event such as a schedule change, equipment change, delay in arrival or departure, cancellation, misconnection, a route change, or any other contingency.

Host computer systems 202 may include other service modules (not shown) that are coupled to OCDB 222, including a ticketing module for managing ticketing activity, an information module for managing automated information such as visa requirements, ticketing rules, luggage policies and procedures, fare rules, promotions and the like, an agreement module to store agreements that exist between an airline and its partners, and a load control module for assisting airline load control agents in planning the distribution of payload aboard an aircraft.

Web servers 200 provide a seamless interface by which remote users 232A-232N or local users (not shown) may access host computer systems 202. Although host computer systems 202 and web servers 200 are illustrated separately in FIG. 2 for exemplary purposes, RDCS 102 may be realized by a single computing device or a plurality of cooperating computing devices such as a clustered computing architecture.

According to the exemplary embodiment of FIG. 2, web servers 200 provide a web-based interface by which authorized remote users 232A-232N communicate with RDCS 102 via network 106. In one configuration, web servers 200 execute web server software, such as software marketed by Microsoft Corporation under the trade designation “INTERNET INFORMATION SERVER.” As such, web servers 200 provide an environment for executing user interface modules 201. User interface modules 201 provide an interface that allows users 232A-232N to manage airline reservations, and perform check-in and re-booking functions. User interface modules 201 may include Active Server Pages, web pages written in HyperText Markup Language (HTML) or dynamic HTML, Active X modules, Java scripts, Java Applets, Distributed Component Object Modules (DCOM), and the like.

User interface modules 201 may execute within an operating environment provided by web servers 200. Alternatively, portions of user interface modules 201 may be downloaded as “client-side” user interface modules 234A-234N that are executed on client computing devices 236A-236N, respectively. Client-side user interface modules 234A-234N could, for example, include Active X components or Java scripts executed by web browsers 238A-238N running on client computing devices 236A-236N, respectively.

It will be understood that the RDCS shown in FIG. 2 is exemplary only. Other systems may include fewer or more modules, may omit or add functionality, and/or may implement similar functionality in alternative ways. Thus, FIG. 2 should be considered as only one of many types of systems that may usefully employ the current invention.

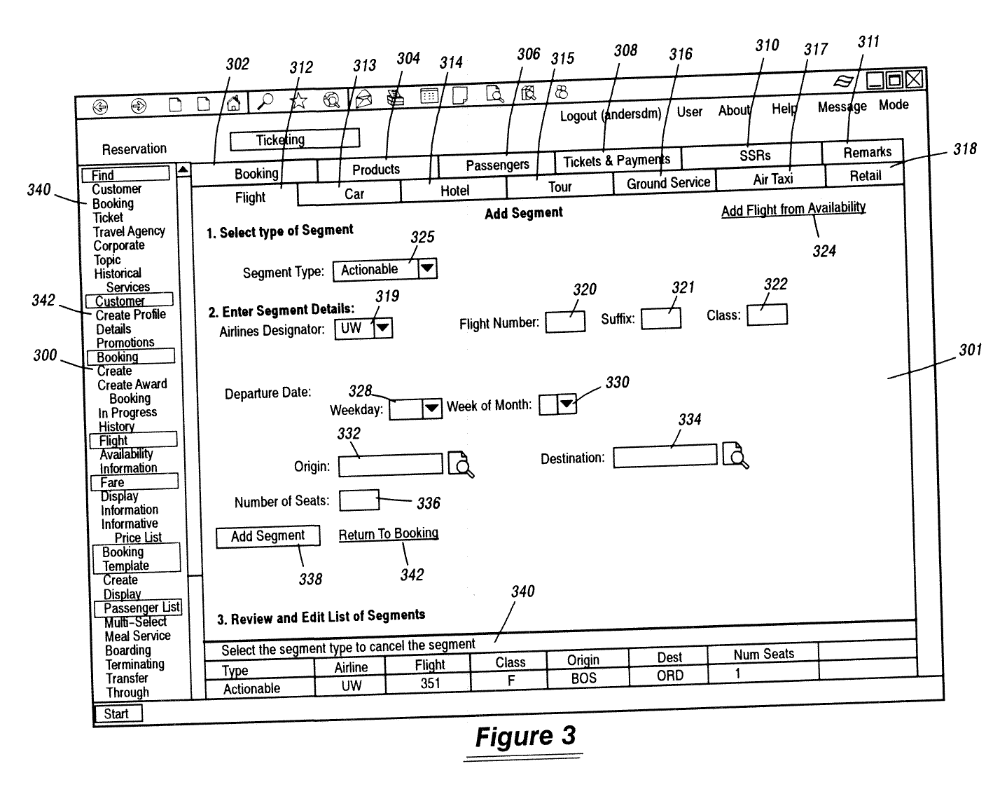

FIG. 3 is a screen display that is included in an exemplary user interface that may be employed by RDCS 102. This screen display may be provided via execution of user interface modules 234A and/or user interface modules 210 (FIG. 2). A menu of available functions appears on the left-hand side of the screen. These functions facilitate booking customers on flights, determining flight availability, boarding passengers, determining fares, obtaining passenger lists, and so on.

The functions shown in FIG. 3 include those for creating a booking. As discussed above, within the transportation industry context, a booking refers to all information that describes a journey that is being taken by one or more people traveling together. Such information includes customer names, the number of segments in a journey, the transportation routes (e.g., flight segments) included within the journey, and any special requirements such as special meals, wheelchairs, etc. that may be needed by one or more of the members in the party while traveling on an airline flight. It may also include other services that are reserved for the trip, such as a vehicle rental, lodging reservations, tour reservations, any other type of entertainment reservations, etc. It may further include an order to secure delivery of goods to a particular location, such as ordering the delivery of a case of wine to a resort suite on a given day of a trip. Any type of goods and services that are included in the trip may be part of the booking. In a larger context that extends beyond merely the travel industry, a booking may refer to all data that describes the goods and services required to conduct a particular event.

In one embodiment, a booking may be created by selecting the create_booking function 300. The selection of the create_booking function results in the generation of a screen display that provides a number of tabs, shown as tabs 302-311 of FIG. 3. Each tab allows a different type of information to be entered for the booking that is under creation. When tab 302 is selected, the booking that is being defined may be displayed, as will be described further below. When the products tab 304 is selected in the manner shown in FIG. 3, various products (also described as “services” herein) may be added to the booking. This will be described in detail below.

The passenger tab 306 may be selected to obtain a screen for adding information regarding each passenger that is involved with the booking. When this tab is selected, a screen is generated that allows a user to specify, for each passenger, a passenger name, and corresponding address, phone and other contact information. In one embodiment, some or all of this information may already be stored within a personal profile for the customer, as may be retained within OCDB 222. The use of personal profiles will be discussed further below.

Tickets_and_payment tab 308 is selected to obtain a screen display that allows a user to choose forms of payment for each of the products added to the booking. In one embodiment, a user may prompt the system to retrieve some of this payment information (e.g., credit card numbers and names) from a personal profile of the type described above that has been created for one or more of the passengers that is associated with the booking. As may be appreciated, this option is only available if such profiles have been previously created for one or more of the passengers. In this manner, the detailed payment information need not be added by hand.

Tab 308 also provides ticketing options, such as whether e-tickets are to be issued for one or more of the services, whether ticket pick-up or delivery (e.g., via mail) is requested for any of the services, and so on.

Tab 310 is selected to obtain a screen display that allows a user to make special service requests (SSRs) for a product that has already been added to the booking. For instance, a user may wish to reserve a vegetarian meal, a wheelchair, or bassinet on a flight that was previously added to the booking. This can be accomplished by selecting the SSR tab 310 and designating the appropriate request.

Finally, tab 311 is selected to obtain a screen display that allows the creator of the booking to enter remarks. For instance, a remark may be added indicating that the passenger will need assistance to board a flight because of a medical condition.

An in-depth description of the various functions represented by most of tabs 302-311 is not provided because these functions are beyond the scope of the current invention. However, more discussion is provided regarding use of the products tab 304.

When the products tab 304 is selected in the manner shown in FIG. 3, the additional tabs 312-318 are displayed on the screen. Each of these tabs corresponds to a different type of product or accommodation (e.g. vehicle, hotel, tour, ground service, air taxi, and retail reservations) that may be added to a booking. Such accommodations are also referred to herein as “services”, as discussed above.

When the flight tab 312 is selected, the main screen area 301 displays functions that are used to add one or more flights to a booking. In this embodiment, the user specifies a flight by designating the airline that hosts the flight in input area 319, the flight number in input area 320, any suffix associated with the flight number in input area 321, and the booking class in input area 322. Some of these fields may be associated with menus to aid in this selection process. For instance, a drop-down menu is provided to aid in selecting the designation for the airline in input area 319.

If the user does not know the flight number, the add_flight_from_availability link 324 may be selected. This brings up a window that allows a user to search flights provided by one or more selected airlines by date, departure and destination locations, and/or pricing in accordance with flight availability search engines known in the art. When a desired flight is located, the user may return to the screen display of FIG. 3 and enter the flight information in the manner described above.

In one embodiment, an input area 325 is provided to allow a flight segment type to be entered. In this case, the segment type is listed as “actionable”, indicating that the flight has not yet been booked and therefore some action must be taken to secure space on the flight. Other flight statuses include “passive” or “no-knowledge” designations that may be added in input area 325. These other types of statuses do not require any action to be taken by an airline and are primarily provided for ticketing purposes, and to give a more complete view of the passenger's itinerary.

Departure day and date for the flight are entered using input areas 328 and 330, respectively. It will be appreciated that this information is required since a particular flight number may be offered on multiple days of the week. Origin and destination airports are specified in input areas 332 and 334, respectively. As shown, a search utility may be provided to obtain the correct airport codes for these locations. Finally, the number of seats to be booked is designated in input area 336. Selection of the add_segment button 338 adds this flight to the booking. Any flights that have been added to the booking so far are shown in screen area 340. This screen area shows that flight UW 351 has been added to the booked.

As noted above, the add_segment button 338 allows a flight segment to be added to the booking. When this button is activated, booking module 212 of RDCS 102 (FIG. 2) initiates the process of booking the number of specified seats for the flight segment. To do this, booking module 212 first makes a request to space module 216 to acquire the necessary space on the desired flight, which in this case is UW 351.

If space module 216 is able to acquire the requested space on the flight, space module will return a response to booking module 212 indicating that the request has been honored and that the requested space has been allocated to the booking. Otherwise, the response will indicate that the requested space is not available. If the space is not available, the booking must be modified and the booking process re-initiated.

If space module indicates that the requested space is available, booking module 212 makes another request to seats module 217 (FIG. 2) for seat assignments. Seats module makes the requested assignments and returns a response to booking module 212.

In the foregoing manner, an airline flight is added to the booking in an automated manner by RDCS 102 of the current embodiment.

At any time during the process, a user creating the booking may select the return_to_booking link 342. This returns the user to the window that contains the definition of the booking that is currently being defined, including a list of all products that have been added to the booking template so far. This view may also be obtained by selecting the booking tab 302.

In a manner that is similar to that described above, the other tabs 313-318 may be selected to add corresponding products to the booking that is under creation. For instance, the car tab 313 may be selected to obtain a screen display in main screen area 301 that allows a user to add one or more vehicle rentals to the booking. Selection of hotel tab 314 results in display of a screen used to add lodging reservations to the booking. Tour tab 315 is selected to obtain a screen for adding one or more of a selected list of tours to the booking. Ground service tab 316 is selected to traverse to a screen for adding a ground transportation service (taxi, shuttle bus, limousine service, etc.) to the booking. The air taxi tab 317 is selected to obtain a screen that allows a user to add an air shuttle service to the booking, as may be used to transport passengers from a major airport to a smaller destination airport. Finally, the retail tab 318 is used to obtain a screen allowing retail services to be added to the booking. For instance, this screen may allow restaurant reservations, tee times, show tickets, and so on, to be acquired. This screen may also provide opportunity to have selected goods delivered to lodging accommodations, for instance.

As described above, when a flight is added to a booking, booking module 212 generates requests to space and seats modules to acquire the necessary space and seats, respectively. In one embodiment, the booking of other services (e.g., hotel, vehicle rental, etc.) occurs in a similar manner. That is, when the user adds the service to the booking by selecting the appropriate function similar to the add_segment button 338 of FIG. 3, RDCS 102 automatically issues requests via RDCS 102 or to similar on-line reservation systems that are communicatively coupled to RDCS 102. For instance, hotel and vehicle rental businesses generally have on-line reservation systems. RDCS 102 may use a predetermined communication link and message protocol to issue a request to another such system. For instance, TTY, XML, EDIFACT, or any other message standard may be used to initiate communication between RDCS 102 and some other system. A message from RDCS 102 will include the information needed to identify the requested service and to complete the booking. The message may include personal and payment information, a service description (e.g., one non-smoking suite with internet access), and so on. Confirmation information may be returned and processed automatically in a similar manner. Confirmation information may then be stored with the other booking data.

If automated on-line reservation systems are unavailable, email, voice mail, and/or facsimile transmissions may be used to make the appropriate service requests. In this case, obtaining reservation confirmation information may require some human assistance, such as by manually extracting the data from return email transmissions and entering this information into the appropriate booking.

In the foregoing manner, virtually any type of service (i.e., product) may be added to a booking using the screens represented by the tabs shown in FIG. 3. It may be appreciated that the list of services available for selection on each of these screens (e.g., the hotels available for selection using a drop-down menu), are maintained by the system administer or some other authorized system representative. These lists may be as extensive, or as limited, as the administrator desires, and may be based on partnerships between various service providers.

The user interface shown in FIG. 3 may be employed by a travel agent, a booking agent who is employed by an airline, a hotel employee, or some other representative to create a booking on behalf of the end-user passenger (also referred to as a “customer”.) Alternatively, the passenger may create the booking on his own behalf by signing onto an appropriate web site, providing the necessary information, and using his customer number to save the booking.

As noted above, within the flight screen obtained upon selecting the flight tab 312, the user may obtain a display of the booking either by selecting the return_to_booking link 342 or by instead selecting the booking tab 312. A similar return_to_booking link may be provided by the other screen displays corresponding to tabs 313-318.

As discussed above, the booking is created in various steps. For instance, a user may first add a flight segment to the booking by traversing to the screen display of FIG. 3, entering the necessary flight details, and then activating the add_segment button 338. The user may then traverse to another screen and enter information for a desired hotel reservation. The user then adds the hotel to the booking by activating an add_hotel button similar to the add_segment button 338 of FIG. 3. Passenger information is added to a booking in a similar way.

Each time the user adds information to the booking in this manner, one or more tables within the booking data 224 (FIG. 2) are updated to record these modifications. Thus, while a booking is being created, booking data 224 may be referenced many times as each new service or new piece of booking information is added to the booking.

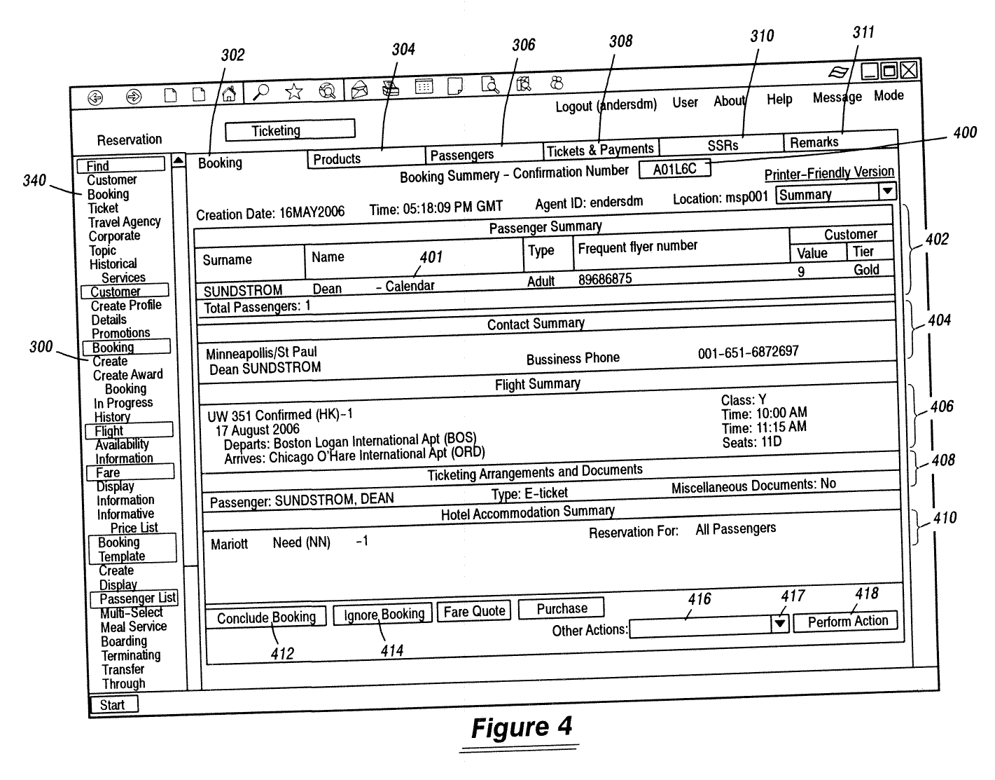

Any newly-stored booking information is considered temporary until an End-of-Transaction (EOT) process is initiated in a manner to be described below in reference to FIG. 4.

FIG. 4 is a display of an exemplary booking summary screen that is provided when booking tab 302 is selected after a booking has been created in the above-described manner. Screen area 402 includes the name of the people associated with this booking. In this case, only one passenger, Dean Sundstrom, is associated with the booking. Screen area 404 includes contact information for Dean. As described above, this information is added to the booking using a screen obtained when the passengers tab 306 is selected. Alternatively, this information may have been previously provided by creating a customer profile that is stored in the OCDB 222. In one embodiment, booking module 212 automatically imports this information from the customer's personal profile stored in OCDB 222 so that the information need not be provided each time a new booking is created for that passenger.

Screen area 406 includes information regarding flight UW 351 which was added to this booking in the manner described above in regards to FIG. 3. Ticketing information for the flight is shown in screen area 408. Screen area 410 includes information about a hotel reservation that involves the booking of one room at the Marriott Hotel. This service was added to the booking by selecting the hotel tab 314 of FIG. 3, as was described above.

A user selects the conclude_booking button 412 when he or she is satisfied that the booking data contains all of the desired services. This initiates the EOT process that stores all of the data for the booking to booking data 224. This EOT process may also create an audit trail so that the changes to the database are recoverable if a system failure should occur. Finally, the EOT process also adds messages to various office queues to record that the services have been reserved. For example, in one embodiment, messages are added to office queues of RDCS 102 to indicate that seat assignments have been made on an airline for this booking.

As noted above, according to the current embodiment, when the conclude_booking button 412 is selected to initiate the EOT process, all information for the booking that is under creation is stored within multiple database tables residing in booking data 224. Each of these tables is dedicated to storing one or more attributes of the booking. For instance, a table may be provided to store flight information for the booking. Another table may be provided to store ticketing information. Still another table may be used to store detailed customer information. In one embodiment, many different tables may be updated during the EOT process, each to store a respective aspect of the booking. The various tables have the capability to store a detailed description of the traveler's itinerary, including data describing all services and all passengers associated with the booking.

In one embodiment, the primary key field for each of the tables is a trip ID. This trip ID, also referred to as a confirmation number shown in screen area 400 of FIG. 4, is automatically assigned to the booking either before, or at the time, the EOT process is initiated. This will be discussed further below.

The foregoing describes how the conclude_booking function is used to make booking data persistent. The user may instead decide to ignore all of the updates that were made to the booking during the current session. This is accomplished by selecting the ignore_booking function 414 (FIG. 4). When this function is selected, the entire booking is discarded.

After the booking is created and stored to booking data 224, a user may retrieve that information. This is accomplished by selecting the find booking function 340 (FIGS. 3 and 4), and then specifying the trip ID (i.e., confirmation number). This will cause the system to retrieve all information from all tables within booking data 224 that is associated with the specified primary key value. The system will then display the booking in a screen such as shown in FIG. 4. The user may modify the booking by adding, deleting, or modifying the services and/or other information included in the booking. Each time a change is added to the booking, the change is recorded to booking data 224. These changes are considered temporary until the user once again selects the conclude_booking button 412 to make the changes permanent in the above-described manner. The changes to the booking made during that session may instead be ignored using the ignore_booking button 414 (FIG. 4).

The foregoing describes the manner in which bookings are initially created and stored, and later optionally retrieved to be updated and stored again. During the creation and the update processes, as new products and services are added, deleted, and/or changed, the booking is continually being stored to retentive storage. For instance, selection of the add_segment button 338 causes the newly-entered flight information to be stored to retentive storage, which in the embodiment of FIG. 2 includes booking data 224. The updates are then made permanent during an EOT process which creates an audit trail and places various messages on office queues to alert automated processes and personnel of the booked services.

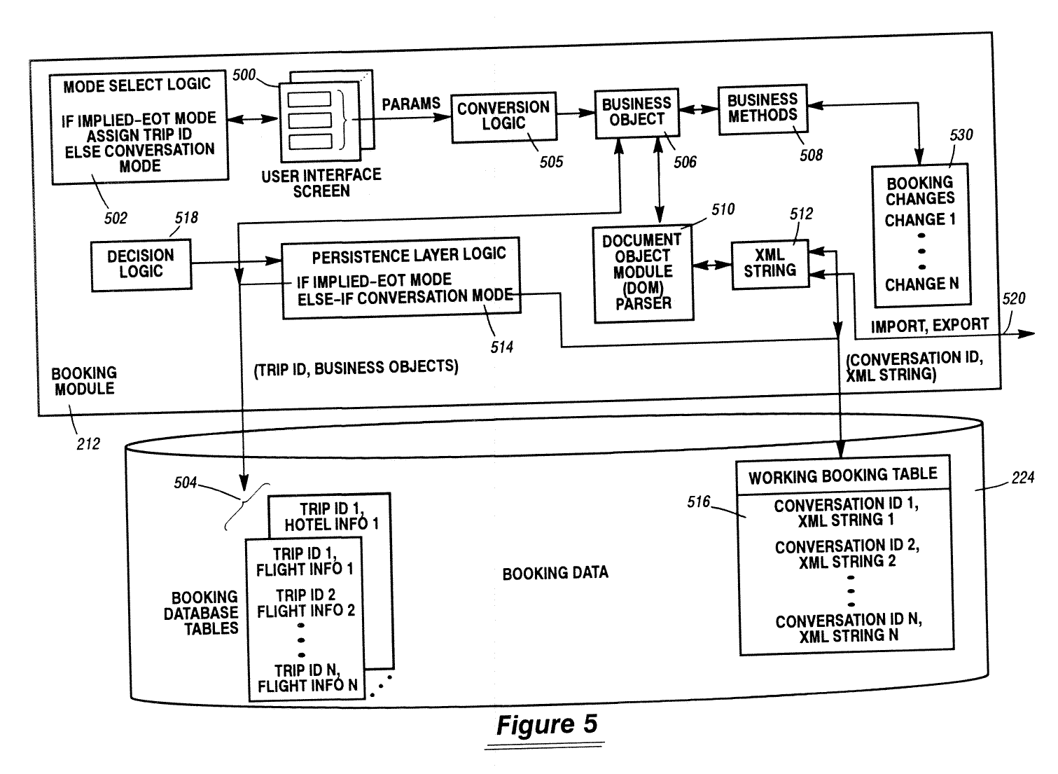

According to the current invention, the way updates are stored to the booking data 224 as the booking is being created varies based on a selected mode of operation. The system of the current invention may operate in either a conversation mode, or an implied EOT mode. These modes are discussed in detail in reference to FIG. 5.

FIG. 5 is a block diagram that illustrates operation of the implied EOT and conversation modes according to one embodiment of the current invention. This diagram illustrates in more detail some of the logic provided by booking module 212, as well as some of the data structures stored within booking data 224. The logic and data structures are described in reference to the two modes of operation as follows.

When a user initiates creation of a booking using the create_booking function 300, the user is presented with user interface screens such as exemplified by FIGS. 3 and 4. These screens are represented by user interface screens 500 of FIG. 5.

The initiation of the process to create a new booking is said to start a “conversation” within the system. As such, a conversation ID is assigned to uniquely identify the session.

Next, in one embodiment, the user is allowed to select whether to operate in implied EOT mode or conversation mode. This selection is made by choosing the booking tab 302, for instance. The drop-down menu 417 associated with the other_actions window 416 (FIG. 4) is then used to obtain a list of functions that includes an implied EOT mode and a conversation mode. The user highlights the desired selection and then activates the perform_action button 418 to complete the mode choice. This selection process is represented by mode select logic 502 of FIG. 5. If implied EOT mode is selected, a trip ID is assigned, as shown by block 502. As discussed above, this Trip ID is the primary key field for the multiple booking database tables 504 shown stored within booking data 224 in FIG. 5. This will be described further below. If conversation mode is selected, no additional ID is assigned, and only the previously-assigned conversation ID is used to identify this current conversation.

As previously discussed, the user is allowed to add services to the new booking using the various user interface screens 500 in the manner described above. During this process, the user is entering various parameters into the fields of the GUI interface. These parameters, or “params”, are received by conversion logic 505 to be converted into business objects 506. Various logic functions, including business methods 508, operate on the business objects 506 to perform the functions required to book the services as those services are being selected. For instance, some of the business objects are responsible for making requests to space module 216 and seats module 217 to obtain space and seat assignments, respectively, for any booked flights. Other ones of business methods 508 are responsible for initiating the booking of other services in a similar manner.

The business objects 506 are available not only to business methods 508, but are also provided to a parser 510. In one embodiment, this parser is a Document Object Module (DOM) parser of the type known in the art. According to the invention, this parser converts the business objects into a string-version of the booking. In one embodiment, the string is in the eXtensible Markup Language (XML) format. This is shown as XML string 512.

As noted above, as new params are received from user interface screens 500 and converted to business objects, persistence layer logic 514 determines that the updates to the booking should be stored to booking data 224 within persistent storage. This persistence layer logic is coupled to decision logic 518, which, among other things, determines whether booking module 212 is operating in implied EOT mode. If so, all of the business objects that embody the booking information that has been added to the booking so far are stored to multiple booking database tables 504 within booking data 224.

As discussed above in regards to the EOT process, each of the booking database tables 504 is dedicated to storing one or more attributes of the booking. For instance, one or more of the tables may be provided to store the business objects that are related to flight information for the booking. Another table may be provided to store the business objects related to ticketing information. Still another table may be used to store the business objects involving detailed customer information. In this manner, many different tables may be updated to record the services and information that are reflected by the booking. In one embodiment, each of the tables uses the trip ID for the booking as the primary key value for the entry created for the respective booking.

If the persistence layer 514 determines that operation is occurring in conversation mode rather than implied EOT mode, persistence layer 514 stores the XML string 512 for the booking within a single working booking table 516 that is retained within booking data 224. In one embodiment, the conversation ID is used as the primary key value for the new table entry.

In the foregoing manner, each time an update is made to the booking as by selecting the add_segment button 338 (FIG. 3), persistence layer determines whether to store the booking information to the booking database tables 504 or to the single working booking table 516. When the booking is saved to the booking database tables, the database call requires more time to complete, since the booking data is being stored to multiple tables. In fact, in one embodiment, forty or more such tables may be used to store the booking information. In contrast, when operating in conversation mode, only a single database table must be updated. This database access may therefore be completed in significantly less time.

Eventually, the user determines whether to initiate the EOT process using the conclude_booking button 412 (FIG. 4) or to instead ignore the changes to the booking by selecting the ignore_booking button 414, respectively. The logic that supports this functionality is included in decision logic 518. If the conclude_booking function is selected, persistence layer 514 stores the business objects 506 that embody the booking to the booking database tables 504 in the manner described above. This is true regardless of whether the system is operating in conversation or implied EOT mode. Various messages are placed on the office queues to indicate services included in the booking have been booked. In one embodiment, an audit trail is created so that updates to the booking are recoverable if a system failure occurs.

The use of the conversation mode provides several important benefits. First, as described above, while the booking is being created, each update is stored to booking data 224. If the system is operating in conversation mode, each such storage operation results in the updating of only the single working booking table 516. If operating in implied EOT mode, however, each such update is implemented via a call to databases 202 that updates all of the booking database tables 504. That is, even those tables that store aspects of the booking that were not affected by the user's most recent update will be accessed by this database call. As a result, the storing of the booking when operating in implied EOT mode takes a much longer period of time to complete than if the system is operating in conversation mode. Thus, implied EOT mode imposes a large amount of overhead on the database, and also slows response times of booking module 212.

The use of conversation mode provides other important benefits. The XML string 512 that is created for use in conversation mode is easily transportable. It provides a universally-understood booking format that may be transferred to other reservation systems for use in completing the reservation of services described by the booking. The booking may likewise be transferred to an end-user's PDA, cell phone, or other electronic processing device. Appropriate parsing software may then be used to convert this XML booking into a readable itinerary. In contrast, the business objects that are stored within booking database tables 504 are not in an easily transportable format, but rather are in a proprietary format that cannot readily be used by other systems to perform functions associated with the booking.

According to one aspect of the invention, a booking stored within booking database tables 504 may be retrieved from booking data 224. This may be accomplished using the find booking function 340, for example. When retrieved from the databases 202, this booking is embodied as business objects 506, as described above. These business objects may then be parsed by the DOM parser 510 to create a corresponding XML string 512, and may then be exported to another system, as by interface 520. Interface 520 may be any type of communication link that is suitable for transmitting an XML string.

In a similar manner, a booking embodied as an XML string may be received on interface 520 from another system. This XML string may be converted into business objects 506 by DOM parser 510 and stored within booking database tables 504. In this manner, bookings may be readily shared between reservation systems, even if such systems do not have similar database structures and formats.

The following illustrates an XML string version of a booking:

<?xml version=“1.0” encoding=“UTF-8” ?>

<trip CId=“17290” FF=“1000344” modif=“true” noSts=“2” own=“1000344”

uSrc=“1”>

<seg aCode=“NN” airDs=“UW” arTm=“1455” cIDs=“Y” crft=“757” dest=“ORD”

dpDt=“21FEB2003” dpTm=“1300” dtChg=“0” fltNo=“251” isCS=“false”
modif=“true” org=“BOS” sCode=“HK” sgNo=“1” />

<seg aCode=“NN” airDs=“UW” arTm=“1915” cIDs=“Y” crft=“A32” dest=“BOS”

dpDt=“21FEB2003” dpTm=“1550” dtChg=“0” fltNo=“350” isCS=“false”
modif=“true” org=“ORD” sCode=“HK” sgNo=“2” />

<seg aCode=“NN” airDs=“UW” arTm=“1445” cIDs=“Y” crft=“757” dest=“ORD”

dpDt=“21FEB2003” dpTm=“1125” dtChg=“0” fltNo=“350” isCS=“false”
modif=“true” org=“DEN” sCode=“HK” sgNo=“3” />

<cust FF=“1000344” csNo=“1” cusVI=“9” frst=“DENISE” last=“ANDERSON”

modif=“true” nSea=“1” prty=“0”>

<ssr actCode=“NN” code=“AVIH” csNo=“0” custId=“0” modif=“true” segId=“0”

sgNo=“1” ssrNo=“1” tot=“1” />

</cust>

<cust FF=“0” csNo=“2” frst=“Mary” last=“Smith” modif=“true” nSea=“1”

prty=“0”>

<ssr actCode=“NN” code=“CHML” csNo=“0” custId=“0” modif=“true” segId=“0”

sgNo=“1” ssrNo=“1” tot=“1” />

</cust>
</trip>

The described booking has a trip ID of “17290”. This trip includes a departing flight segment on flight UW 251 from Boston (BOS) to Chicago (ORD) and a returning flight segment on flight UW 350 from Chicago to Boston. The trip involves Denise Anderson, who has a frequent flier number 1000344, and Mary Smith. This booking includes additional information, such as the type of aircraft providing the flight, and so on.

In the foregoing manner, performance and other benefits that are provided by a conversation mode which may be used to create an XML version of a booking.

In addition to conversation mode, the booking module 212 of the current invention provides yet another performance improvement. This improvement relates to how modifications may be made to the booking data as it is being created. This may be appreciated by returning to FIG. 5.

As noted above, a user builds a booking incrementally. The user may add one or more flight segments to the booking. The user may then add a hotel reservation and/or a car rental. At some point during this process, the user may determine that some previously-selected service(s) must be removed from the booking and different services must be added instead. Alternatively, the user may determine that the customers associated with the bookings have changed, or that some information originally entered for those customers was in error. This will necessitate making changes to the booking.

In prior art systems, such changes can only be made by ignoring the entire booking, such as by selecting the ignore-booking button 414 (FIG. 4). This is because prior art systems do not have any way to cancel just a portion of the booking. As a result of this limitation, all services that have been booked so far must be “un-booked”. For instance, this causes booking module 212 to make a request to space and seats modules, 216 and 217 to “give back” any space and seats, respectively that had been reserved for the booking. In a similar manner, booking module makes requests to undo all of the services that had been reserved for the booking so far.

In prior art systems, mechanisms similar to the foregoing are used to ignore changes when a user is updating an existing booking. After the user retrieves data for an existing booking, a new conversation, or update session, is started. The user may add new services and/or information to the booking during this update session. If even one of these additions is determined to be unnecessary or in error, all of the new information entered during that conversation must be ignored, as by selecting a function similar to ignore_booking button 414. This is because there was no way to identify selected portions of data from a same booking for deletion from the booking database tables 504.

As may be appreciated, the prior art requirement of ignoring or saving all changes made during a conversation is inefficient. If a user makes even one mistake, all of the changes to the booking during that conversation must be discarded. The booking module 212 of the current invention eliminates this requirement by providing a partial_ignore function. The operation of this function will be described first in relation to creating a booking, and then in relation to modifying an existing booking.

When a booking is being created, it may be created in either conversation mode or implied EOT mode, as described above. When in conversation mode, the updates are being stored to the working booking table 516 as an XML string, and when in implied EOT mode, the updates are being stored within booking database tables 504 as business objects. In either case, at any time before the conclude_booking function is initiated, the user may undo any of the changes made to the booking during the creation process. This occurs as follows.

The user selects the partial_ignore function that is available when the drop-down menu associated with the other_actions window 416 of FIG. 4 is utilized. The user then selects the perform_action button 418 of FIG. 4 to invoke this function.

If the system is operating in conversation mode, the most up-to-date version of the XML string is obtained. In one embodiment, this string may be obtained from local storage such as memory accessible to booking module 212. In another embodiment, this string may be retrieved from working booking table 516. The XML string is submitted to DOM parser 510, which converts the string into business objects 506. One or more of the business methods 508 executes to generate a screen display 530 that provides a user with a menu of all of the services and other information that have been added to the booking since its creation. The user may then select one or more of these changes to ignore as by highlighting the change(s) with a cursor device and selecting the partial_ignore function available in screen area 416 (FIG. 4).

After the user selects the services to ignore, one or more business methods 508 operate to issue requests to cancel the reservations for these services. For instance, one or more methods 508 may issue requests to space and seats modules 216 and 217 respectively to cancel the space and seat assignments that were made for a flight reservation. The information for these services is removed from the booking. In a similar manner, other services may be cancelled from the booking.

The partial_ignore function may also be invoked when a booking is being created in implied EOT mode. In this case, the booking may be retrieved from the booking database tables 504 or from local storage space (e.g., memory accessible to booking module 212.) The business objects that comprise this booking are then accessed by one or more business methods 508 to generate a screen display of all of the services and other information that have been added to the booking so far, such as is shown in block 530 of FIG. 5. The user may select any one or more of the displayed items to ignore. In response, one or more of the business methods 508 operates to cancel the services that are being ignored and remove related information from the booking.

The partial_ignore function may also be used to ignore information entered to an existing booking after it has been retrieved from booking database tables 504 for update purposes. For instance, a user may employ the find booking function 340 to retrieve an identified booking from booking database tables 504. The user may then begin making changes to the booking, such as adding and/or deleting services and/or information to/from the booking. If the user determines that any of the changes made since the booking was retrieved from the booking database tables 504 are to be ignored, the user invokes the partial_ignore function in the manner described above. One or more of the methods 508 operate to determine which changes were made during this conversation, which is the period since the booking was retrieved from the booking database tables. The user is presented with the list of changes, and is allowed to select one or more of the changes to cancel. One or more other methods 508 then operate to cancel the reservations associated with any ignored services, and to remove ignored information from the booking.

When an existing booking is being updated, the partial_ignore function may be used to “add back” services that were cancelled from the existing booking, or to conversely cancel services that were added to the booking. Consider, for instance, previously-booked flight segments that were canceled during the current update period. This cancel operation associates special indicators with these flight segments that will cause these segments to be stored in a “cancel space” in local storage. Eventually, this will cause requests to be issued to the space and seats modules to cancel these flight segments.

After a flight segment has been cancelled during a current update session, the partial_ignore function may be invoked to undo this cancellation. This causes the special indicators to be cleared so that requests are not issued to cancel the segments. Additionally, any action/status codes for these flight segments are returned to pre-cancellation status.

In some cases, a booking may contain Advanced Passenger Information (API). This information involves the capture of a passenger's biographic data and other flight details by the carrier prior to departure. This information may be transmitted by electronic means to border control agencies in the destination country for security purposes. This information may also act as a decision making tool to determine whether a passenger will be permitted to board an aircraft.

During an update of a booking, a flight may be cancelled that is associated with API information. If the partial_ignore function is later invoked on that flight cancellation, the cancellation of the API association is also ignored. If the cancellation only involved the API information and not the flight segment itself, and the partial_ignore function is invoked on this API cancellation, the API is reinstated.

Some bookings may contain a fare quote or an informational fare quote. If such a quote is deleted, and the partial_ignore function is used to negate this deletion, the fare quote or informational fare quote is reinstated. If the fare quote is in the “pricing needs verification” condition when it was deleted, it remains in that condition if it is reinstated using the partial_ignore function.

As discussed above, the partial ignore process requires that the system determines which of the changes were made during the current update process. In one embodiment, this occurs as follows. When a user is updating an existing booking, the user is, by default, placed in conversation mode. In this mode, the updates to the booking made during this update period will not be stored within the booking database tables 504, but instead will be stored within working booking table 516 as an XML string in the manner described above. If the user invokes the partial_ignore function, booking module uses the conversation ID for the current update session, or conversation, to read the latest version of the booking from working booking table 516. Booking module also uses the trip ID to read the (older) version of the booking that is stored within the booking database tables 504. These two versions are compared by one or more of the business methods 508 to determine which changes will be presented to the user within the update screen, as represented by block 530 of FIG. 5.

In the embodiment described herein, the user is only allowed to ignore changes that are made during the current conversation. This is true because the sale of services that were added to the booking during past conversations is already considered final. In another embodiment wherein this is not the case, all services may be considered for cancellation during the partial_ignore process.

As discussed above, a user may also utilize the partial_ignore function on a booking that is being newly-created, and has not yet undergone the EOT process for the first time. In this case, when the partial_ignore function is invoked, data for the booking is retrieved from either booking database tables 504 or working booking table 516 and presented to the user as the booking changes 530. In this instance, all information in the booking was added during the current conversation and is therefore considered “new”. Thus, no comparison is required between this new version of the booking and an older version in order to identify which changes are eligible to be discarded.

In the above-described manner, the partial_ignore function allows an agent or an end-user to ignore individual elements that have been added or deleted to a booking during the current session, or conversation. This is in contrast to the ignore_booking function invoked when button 414 is selected, which requires that all changes in the session be ignored or rolled-back.

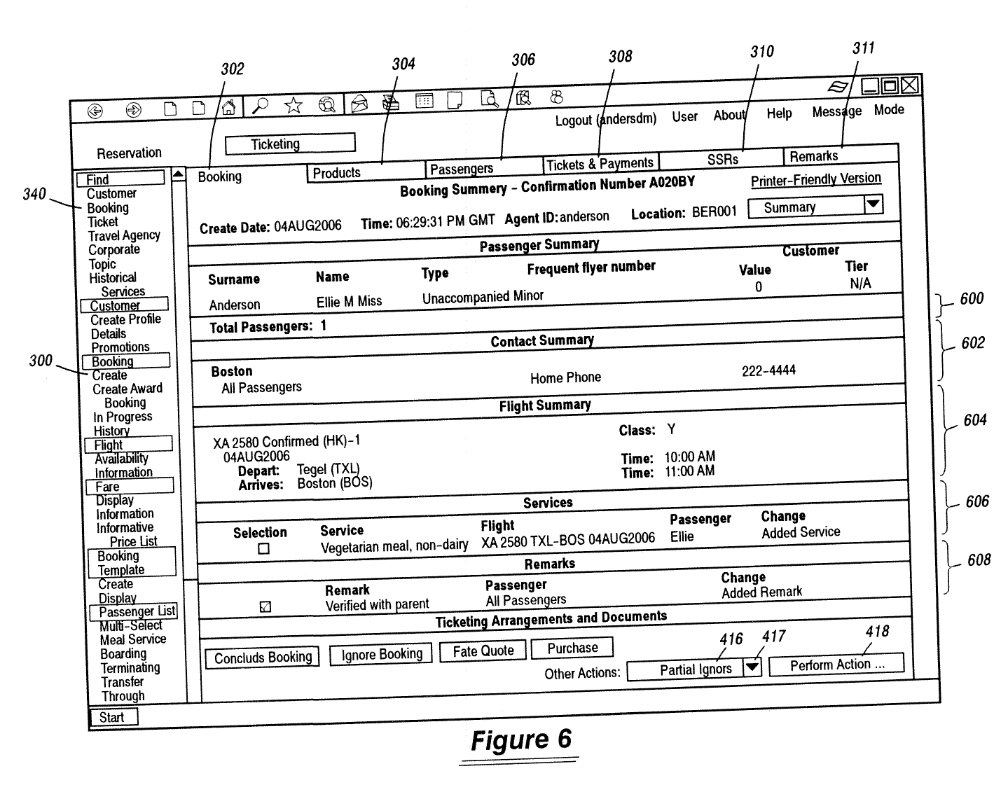

FIG. 6 is a screen display illustrating the addition of services to an existing booking. This booking, which has the trip ID (i.e., confirmation number) of A020BY, is retrieved from the booking database tables 504 using the find booking function 340. When the booking was retrieved, it included passenger summary information in screen area 600, contact summary information in screen area 602, and a single flight described in screen area 604. The user then adds another service to the booking, which involves a vegetarian meal to be provided on the flight. This type of service, which may be added by selecting the SSR tab 310, is shown in screen area 606. Additional remarks are added in screen area 608. Thus, the additional products and information that were added to the booking during this conversation, or update session, are shown in screen areas 606 and 608.

The user then determines that some or all of the updates made during this conversation are to be ignored. The user therefore uses drop-down menu 417 to select the partial_ignore function, which is shown in input window 416. The user activates this function by selecting the perform action button 418.

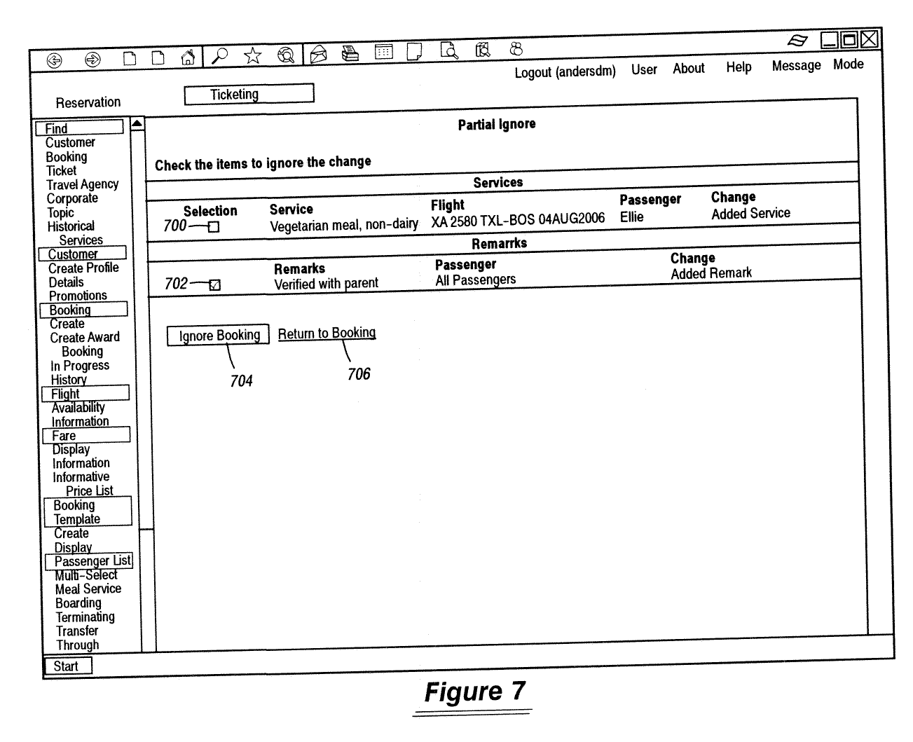

FIG. 7 is a screen display generated when the partial_ignore function is invoked during the scenario of FIG. 6. The screen display provides a list of all information and services added during this conversation, including the addition of the vegetarian meal and the remarks. The user may use check boxes 700 and 702 to indicate that one or both of these elements are to be removed from the booking. In this case, the user is indicating that only the remarks section is to be removed. The user then selects the ignore items button 704. This causes one or more of business methods 508 to remove the information from the booking by removing the information from both the business objects 506 representing the booking, as well as the XML string version 512 of the booking (FIG. 5). The appropriate business methods also take any necessary actions to initiate requests to undo the previous updates in the aforementioned manner.

After the partial_ignore function has been completed by invoking the ignore items button 704, the user may re-display the current state of the booking by selecting the return-to-booking link 706. This will generate a display similar to that shown in FIG. 6 with the exception that the remarks section will no longer be included in the booking.

As noted above, in one embodiment, whenever a user performs an update to an existing booking, the system enters the conversation mode by default. During the update period, all changes to the booking are stored to the working booking table 516. As noted above, this improves performance over that which would be achieved if operating in implied EOT mode wherein multiple table updates are made each time a user modifies the booking. Since it is likely that some or all of the updates will be ignored using the partial_ignore function, there is no reason to make the more time-consuming call to update the booking database tables until it is known that the changes to the booking will be made permanent by invoking the EOT process.

The above discussion describes how an existing booking may be retrieved from booking database tables 504 and updated. Some of the updates may then be ignored using the partial_ignore function. The current embodiment of the invention causes updates to be made, by default, in conversation mode. Therefore, when the partial_ignore function is invoked, the changes from the latest conversation may be identified by comparing the updated state of the booking in the working booking tables 516 to the older state of the booking as it exists within booking database tables 504. The system uses this comparison to determine which services and information will be included in the partial_ignore screen (FIG. 7).

In an embodiment wherein updates are not necessarily made in conversation mode, some other mechanism is needed to determine which changes are not yet considered permanent. For instance, an indicator may be assigned to each “temporary” change for which the EOT process has not yet been invoked. Conversely, an indicator may be assigned to “permanent” changes for which the EOT process has already occurred. The partial_ignore function may then use these indicators to identify the changes made during the latest conversation, and which are therefore eligible to be ignored.

In the foregoing manner, the conversation mode and partial_ignore functions work together to improve system performance. Moreover, these functions help make the creation and updating of a booking less tedious for a user.

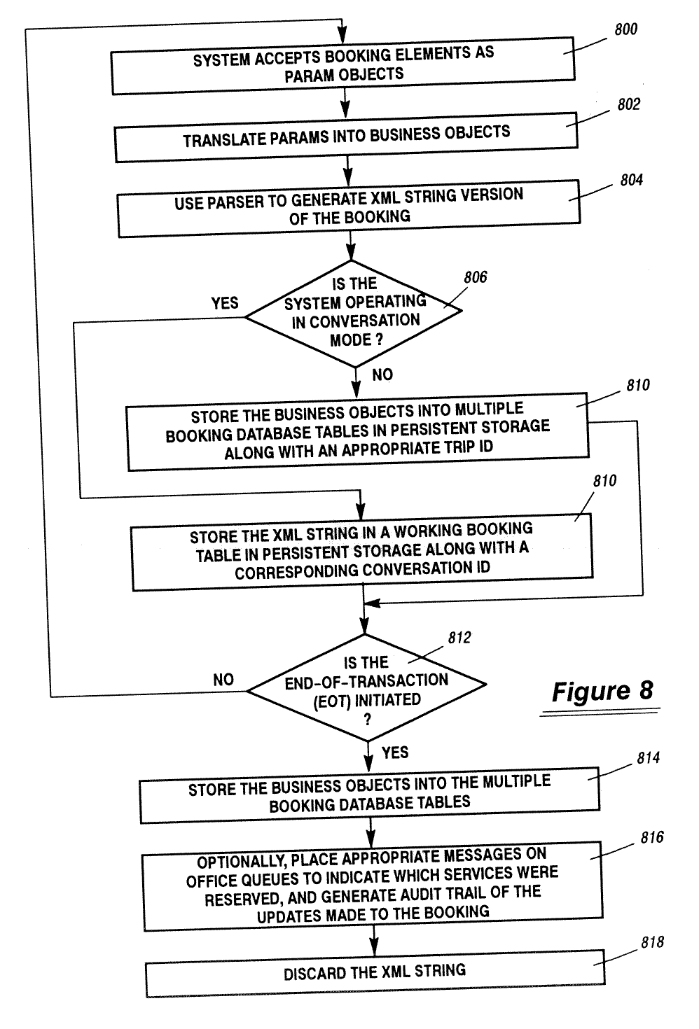

FIG. 8 is one embodiment of a method of providing conversation and implied EOT modes according to the current invention. A user interface is provided that accepts booking elements as param objects (800). These param objects are translated into business objects (802). A parser such as a DOM parser is then used to generate an XML string version of the booking (804). If the system is operating in conversation mode (806), the XML string version of the booking is stored in a working booking table in persistent storage along with a corresponding conversation ID (810). Otherwise, the business objects that embody the booking are stored into multiple booking database tables in persistent storage along with an appropriate trip ID (808).

If the end-of-transaction (EOT) process is initiated (as by activating a conclude booking button) (812), the business objects that embodiment the current version of the booking are stored in the multiple booking database tables 504 in persistent storage, regardless of whether operation is occurring in conversation or implied EOT mode (814). Optionally, the EOT process will also involve placing appropriate messages on office queues to indicate which services were reserved. This process may also involve generating an audit trail to record the updates made to the booking for use if a system failure should occur (816). After the EOT process is completed and the booking is stored to the multiple booking database tables, the XML string version of the booking may optionally be discarded (818).

Returning to step 812, if the EOT process is not initiated, processing returns to step 800 where the system continues to accept additional booking elements.

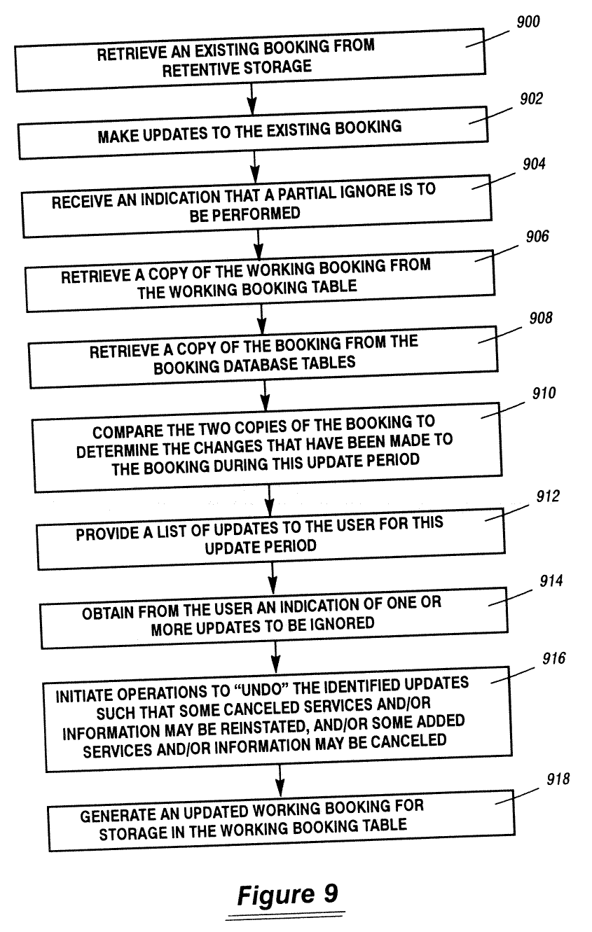

FIG. 9 is one embodiment of a method of a partial_ignore function according to the current invention. This embodiment relates to utilizing the partial_ignore function on a previously-created booking for which an EOT process has already been performed at least once. An existing booking is retrieved from retentive storage (900). Updates are made to this booking, as by a user engaging a user interface (902). The system then receives an indication that a partial_ignore function is to be performed (904). In response, the system retrieves a copy of the working booking from the working booking table (906). The system also retrieves a copy of the booking from the multiple booking database tables in retentive storage (908). The two retrieved copies are compared to determine which aspects of the bookings were added during the current update period (910) A list of these updates are provided to the user (912). The user may then indicate which one or more updates are to be ignored (914). Upon receiving the user's selection(s), the updates are “undone”, which may result in cancelled services and/or information being reinstated, and/or added services and/or information being canceled (916). An updated version of the working booking may then be generated for storage in the working booking table (918). This updated version will not contain the ignored information and/or services.

The foregoing systems, methods, and user interface screens are merely exemplary, and many other embodiments are possible within the scope of the current invention. For instance, the steps of the illustrative methods may, in many instances, be re-ordered without affecting the functionality of the process. Some of the steps may be deleted entirely. Other system architectures may be adapted for use with the invention. Moreover, the invention may be adapted for use in booking any type of event, and is not limited to use solely in booking trips. Thus, the scope of the invention should only be determined by the Claims that follow, and their equivalents.

What is claimed is:

1. A system for managing a booking for an event, comprising:
a user interface to receive data that describes the event;
persistence layer logic coupled to the user interface to store a first version of the data that describes the event in a first format and to store a second version of the data that describes the event in a second format;
business method logic to compare the first version of the event and the second version of the event to identify a subset of the data that is eligible to be ignored; and
allowing a user to select a portion of the subset of the data to ignore.

2. The system of claim 1, wherein the first version of the data is stored in a single database table during a single access operation.

25. The system of claim 1, wherein the first version of the data is stored in a portable string format.

3. The system of claim 1, wherein the second version of the data is stored as business objects.

4. The system of claim 1, wherein the first version is obtained by parsing the second version.

28. A storage medium having stored thereon instructions to cause a processor to execute a method, comprising:
receiving data that describes a booking for an event;
using the received data to perform at least one of
canceling a service from the booking,
deleting information from the booking,
adding a service to the booking, and
adding information to the booking;
allowing a user to initiate a partial ignore function for a portion of the received data that has not yet undergone an end-of-transaction process, the partial ignore function to perform at least one of
reinstating a canceled service within the booking,
reinstating deleted information within the booking,
deleting an added service from the booking, and
deleting added information from the booking.
